(19) United States
(12) Patent Application Publication
(10) Pub. No.: US 2016/0291323 A1
(43) Pub. Date: Oct. 6, 2016

(54) Vehicular Rear or Exterior Camera Lens Cleaner

(71) Applicants: Graham Fishman, West Bloomfield, MI (US); Susan Fishman, West Bloomfield, MI (US)

(72) Inventors: Graham Fishman, West Bloomfield, MI (US); Susan Fishman, West Bloomfield, MI (US)

(21) Appl. No.: 14/677,986

(22) Filed: Apr. 3, 2015

(51) Int. Cl. G02B 27/00; B60R 1/00

(52) U.S. Cl. CPC G02B 27/0006; B60R 1/00

(57) ABSTRACT

A canister system is provided which either stands on its own or utilizes a plastic applicator with an orifice capable of dispensing a pressurized non-freezing cleansing solution to spray upon an occluded vehicular camera lens or ultrasonic sensor fascia cover. An optional non-abrasive integrated brush may be attached to the applicator to aid in clearing the occlusion after spray.

### CROSS REFERENCE TO RELATED APPLICATIONS

This application claims the benefit of U.S. Provisional Application No. 61/995,406, filed on Apr. 9, 2014. The disclosures of the above applications are incorporated herein by reference.

### FIELD

The present disclosure is related to portable, hand-held devices that can be used to clean the debris off of a vehicular external camera lens, rear camera lens or rear ultrasonic sensor fascia cover. When these items are compromised by debris they may interfere with the vehicle driver's ability to safely move backward or sideways to avoid collisions with other obstacles or to avoid stationary objects when moving in reverse via notification by the rear fascia sensors. More particularly, the invention relates to devices that permit an individual to spray a non-freezing cleansing solution with the aid of a propellant upon any external or rear camera vehicle lens to remove debris without having to wipe the lens with a finger, cloth, rag or towelette. This in turn should enable the operator of that vehicle to have a clearer and potentially unobstructed view of potential objects directly behind the vehicle as it is driven in reverse or in the side field view of vehicles as moving sideways in the direction of your vehicle.

Utilization of external or rear vehicular cameras has increased on vehicles to permit the drivers and operator of these vehicles the opportunity to observe, review and respond to obstacles present in the rear driving space of the vehicles and in surrounding left and right sides of a vehicle. These rear camera lenses will be required on all U.S. vehicles by the 2018 model year. During inclement weather or in the presence of roadways with particulate, the lens may likely be covered and coated with debris that impairs the ability to clearly see the image projected on the interior vehicle camera display.

The present disclosure may also be applied to cleanse portions of the vehicular ultrasonic sensor fascia covers.

The present disclosure may also be applied to cleanse vehicular side mirror mounted camera lenses.

### DISCUSSION OF THE RELATED ART

Rear vehicle cameras have been an option on vehicles to permit drivers of vehicles to view the area behind their vehicle as they move in a reverse direction and allow them to see if that rear area is clear or contains a potential obstacle to avoid. This feature has become more populated on vehicles to permit the drivers and operators of these vehicles the opportunity to observe, review and respond to obstacles present in the rear driving space of the vehicles and on the sides of vehicles so equipped with cameras positioned in the side mirrors.

The National Highway Safety Transportation Agency has mandated that new vehicles under 10,000 pounds sold in the United States must have a rear vehicle camera system by May 2018. The rear vehicle or side mirror mounted camera lenses may at times be covered with debris, i.e. ice, snow, mud etc. which will impede the view of the area behind the vehicle as it moves in a reverse direction or as it moves to either side. The vehicle driver has a few options to address the impediments on the exterior camera lenses, 1) do nothing and leave the interior camera display impeded, 2) wipe it with their finger or a piece of material which may smudge the lens and interfere with the clarity of the interior camera display, 3) have it cleaned at the car wash or 4) use the proposed hand-held devices to spray and clear the debris away.

### SUMMARY

It is an object of the present teachings to provide a system that assists vehicular drivers while in the reverse vehicle setting to alleviate visual blockage that can be projected to the interior camera viewer display. To this end the teachings herein introduce a means to cleanse and clear the lens of a vehicular camera whose purpose is to provide a clear image display to the driver of the vehicle and assist them to avoid contact with pedestrians and other stationary objects behind the vehicle while traversing in the rear vehicle direction or the adjacent left and right sides of the vehicle. It is desirable to provide portable, lightweight hand-held devices to owners and operators of automotive vehicles equipped with rear or external vehicular cameras. These devices may include disposable, recyclable metal canisters that contain propellant and a low-freezing point solution that can remove debris deposited upon the lens of the vehicular rear or external camera lens. The canister may also be inserted downward into the top open end of an angled plastic applicator; the other end of the applicator is an open circle, rectangle or geometric oval. This open end of the applicator is then positioned within a few millimeters of the rear or external camera lens while the user presses the exposed bottom end of the canister which is located at the top end of the applicator. Pressing the bottom of the canister will activate the canister metered valve to open. The propellant within the canister will force the low-freezing point solution through the metered valve and valve stem to be expelled through the applicator orifice. When the applicator is properly aimed, the solution will erode or dislodge debris from the debris-covered lens without streaks or smudges or alternatively the canister may be held by hand as a standalone spraying and cleansing device.

This application claims the benefit of U.S. Provisional Application No. 61/995,406, filed on Apr. 9, 2014. The disclosures of the above application are incorporated herein by reference.

In one embodiment the teachings introduce an expendable canister with a combination of propellant and cleanser which will expel a non-freezing cleansing solution which when deposited on the camera lens will erode and strip away the undesired debris on the lens.

In another embodiment the teachings introduce an expendable canister with a combination of propellant and cleanser which is held as a standalone unit by the user.

In another embodiment the teachings introduce an expendable canister with a combination of propellant and cleanser which is inserted into an applicator.

In another embodiment the teachings introduce an expendable canister with a combination of propellant and cleanser which is inserted into an applicator with a non-abrasive integrated brush.

In another embodiment the teachings introduce an expendable canister with a combination of propellant and cleanser which provides a flow rate of 30 liters/minute for 200 milliseconds.

In another embodiment the teachings introduce an expendable canister with a combination of propellant and cleanser which provides a circular dispersion pattern of 18 millimeters to 22 millimeters when placed 25 millimeters from the targeted lens with nominal spray angle of 38.6 degrees for a handheld spray applicator with embedded canister.

In another embodiment the teachings introduce an expendable canister with a combination of propellant and cleanser which provides a circular dispersion pattern of 18 millimeters to 22 millimeters when placed 50 millimeters from the targeted lens with nominal spray angle of 21.8 degrees for a handheld spray applicator with embedded canister.

In another embodiment the teachings introduce an expendable canister with a combination of propellant and cleanser which provides a circular dispersion pattern of 18 millimeters to 22 millimeters when placed 75 millimeters from the targeted lens with nominal spray angle of 14.9 degrees for a handheld spray canister.

### BRIEF DESCRIPTION OF THE DRAWINGS

The present teachings will become more fully understood from the detailed description and the accompanying drawings, wherein:

FIG. 1 is a perspective view of the teachings of a Vehicular Rear or Exterior Camera Lens Cleanser.

FIG. 2 is a cross-sectional view of the teachings of a Vehicular Rear or Exterior Camera Lens Cleanser (shown in FIG. 1).

FIG. 3 is a perspective view of the teachings of the Vehicular Rear or Exterior Camera Lens Cleanser applicator system with replaceable canister.

FIG. 4 is a front view of the teachings of the Vehicular Rear or Exterior Camera Lens Cleanser applicator system (shown in FIG. 3) with replaceable canister.

FIG. 5 is a is a cross sectional view of the teachings of the Vehicular Rear or Exterior Camera Lens Cleanser applicator (shown in FIG. 3) with replaceable canister.

FIG. 6 is a perspective view of the teachings of the Vehicular Rear or Exterior Camera Lens Cleanser applicator system with a non-abrasive integrated brush with replaceable canister.

FIG. 7 is a cross-sectional view of the teachings of the Vehicular Rear or Exterior Camera Lens Cleanser applicator system with a non-abrasive integrated brush (shown in FIG. 6) with replaceable canister.

FIG. 8 is a front view of the teachings of the Vehicular Rear or Exterior Camera Lens Cleanser applicator system with a non-abrasive integrated brush (shown in FIG. 6) with replaceable canister.

FIG. 9 is a perspective view of the teachings of the Vehicular Rear or Exterior Camera Lens Cleanser (shown in FIG. 1) applied to the vehicle rear camera lens.

FIG. 10 image groupings, a, b, c & d are views of the vehicle rear camera lens and interior display screens before and after application of cleansing solution.

FIG. 11 is a perspective view of the teachings of the Vehicular Rear or Exterior Camera Lens Cleanser with a non-abrasive integrated brush (shown in FIG. 6) applied to the vehicle rear camera lens.

FIGS. 12(a) & (b) is a perspective view of the teachings of the Vehicular Rear or Exterior Camera Lens Cleanser applied to the vehicle side mirror camera lens with standalone canister (shown in FIG. 1) or applicator canister (shown in FIG. 3).

FIG. 13 is a perspective view of the teachings of the Vehicular Rear or Exterior Camera Lens Cleanser shown in FIG. 1 applied to the ultrasonic sensor fascia cover.

### DETAILED DESCRIPTION OF THE PREFERRED EMBODIMENTS

The following description of the preferred embodiments concerning an apparatus and method for cleansing a vehicular rear or exterior camera lens coated with debris is merely exemplary in nature and is in no way intended to limit the teachings, its application, or uses.

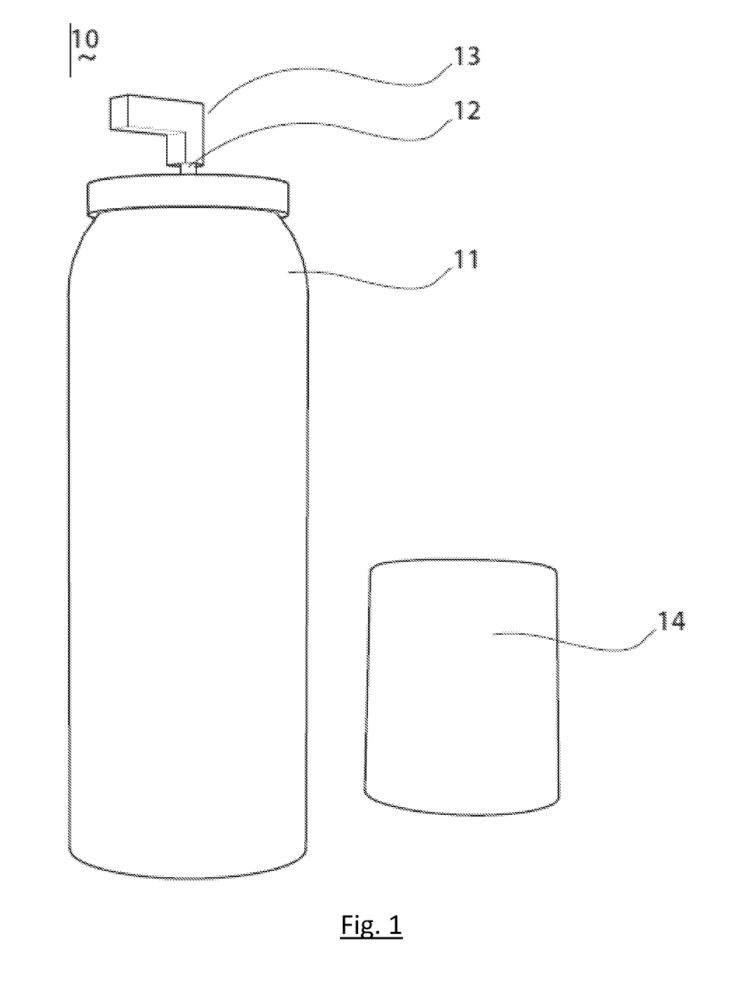

FIG. 1 is a perspective view of the teachings of the Vehicular Rear or Exterior Camera Lens Cleanser, system 10 which can be applied to cleanse a vehicular camera lens or the ultrasonic sensor fascia cover on a vehicle. The system 10 contains an aerosol spray canister 11 with spray nozzle 13 attached to the canister 11 by metered valve stem 12. When not desired to be in use, the canister 11, metered valve stem 12 and spray nozzle 13 can be covered by a protective cap 14. The spray nozzle 13 is rotatable about the metered valve stem 12 to assure positioning if needed to aim at the targeted camera lens area. A non-freezing cleansing solution will be expelled from canister 11 when the metered valve stem 12 is activated by pressing spray nozzle 13.

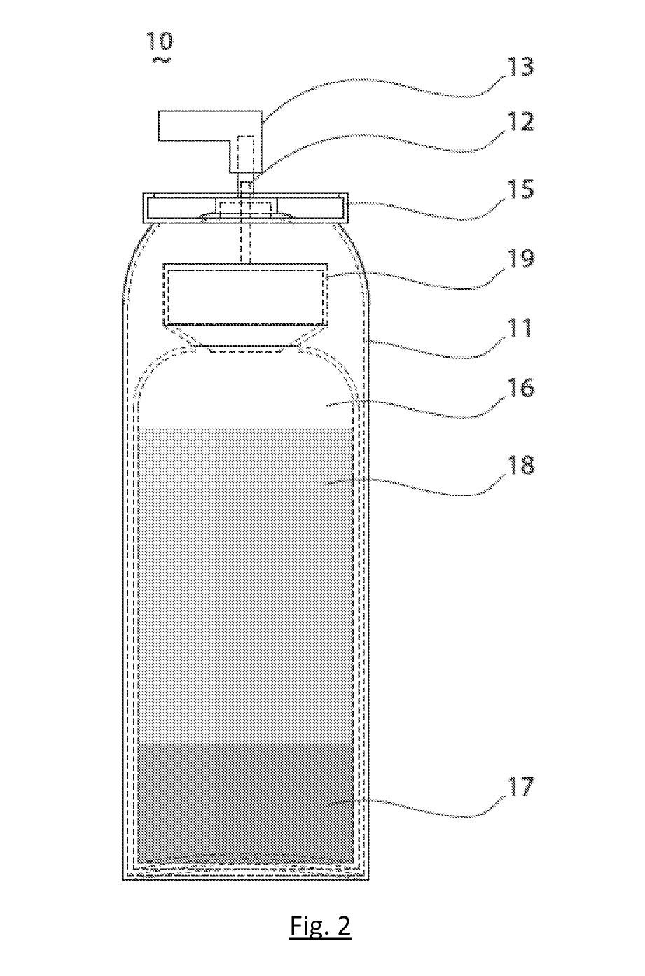

FIG. 2 is a cross-sectional view of the teachings of the Vehicular Rear or Exterior Camera Lens Cleanser shown in FIG. 1, system 10 contains an aerosol spray canister 11 with spray nozzle 13 attached to the canister 11 by metered valve stem 12 which is part of the metered valve 19 crimped 15 to canister 11 to assure the pressurized non-freezing cleansing solution 16 will not escape. The non-flammable, non-freezing cleansing solution is comprised of a propellant 17 and cleanser 18 under pressure which will be expelled from canister 11 when the metered valve stem 12 is activated by pressing spray nozzle 13. When the cleansing solution 16 is expelled from the canister 11 out of the spray nozzle 13 via the metered valve stem 12, pressurized solution turns into an aerosol and once deposited on the camera lens, the cleansing solution 16 will erode and strip away the undesired debris on the lens.

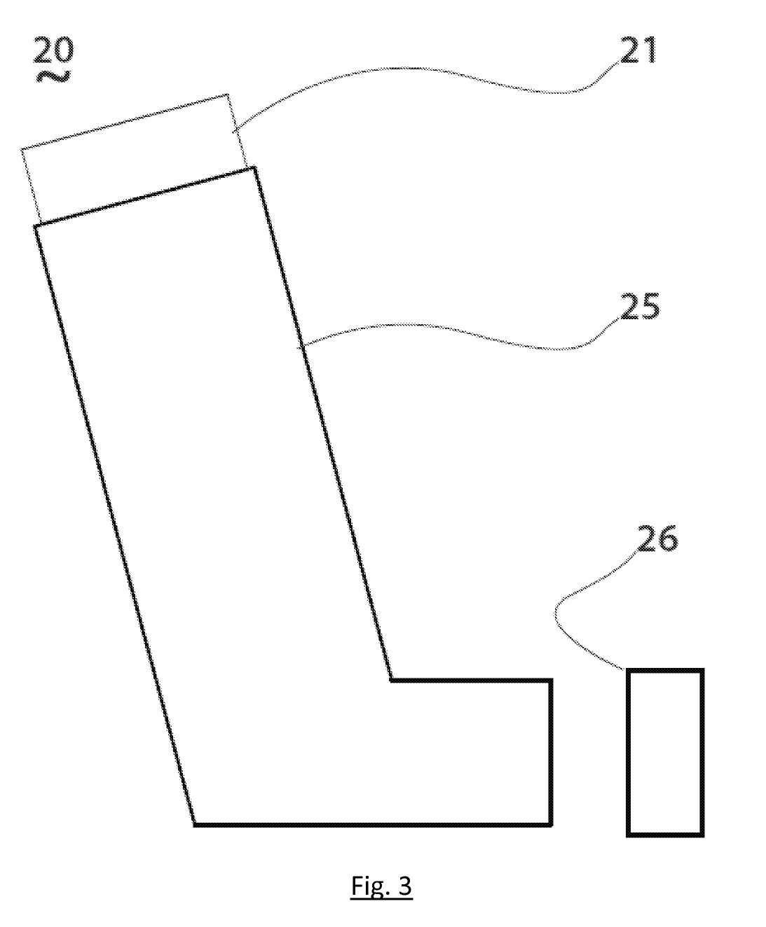

FIG. 3 is a perspective view of the teachings of the Vehicular Rear or Exterior Camera Lens Cleanser applicator system with replaceable canister, the system 20 contains an aerosol spray canister 21 with an internal metered valve which is inserted into the applicator 25. When it is desired to spray the canister contents onto the target area, the user presses the bottom of the canister 21 which is positioned downward into the applicator 25. The internal metered valve then releases the cleansing contents through the internally molded exhaust channel orifice. When not in use, the protective cap 26 will prevent undesired cleansing fluid release.

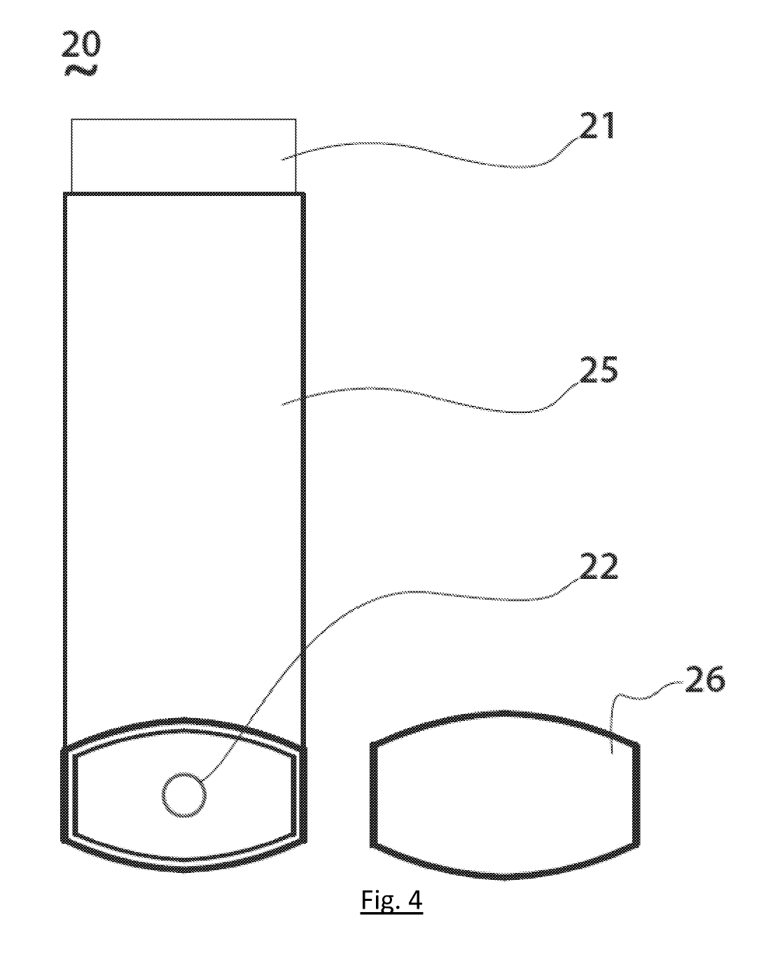

FIG. 4 is a front view of the teachings of the Vehicular Rear or Exterior Camera Lens Cleanser applicator system shown in FIG. 3 with replaceable canister 21 of system 20 which can be applied to cleanse a vehicular camera lens. The system 20 contains an aerosol spray canister 21 with an internal metered valve which is inserted into the applicator 25. When it is desired to spray the canister contents onto the target area, the user presses the bottom of the canister 21 which it positioned downward into the applicator 25. The internal metered valve then releases the cleansing contents through the internally molded exhaust channel orifice 22. When not desired to be in use, the protective cap 26 will prevent undesired cleansing aerosol release.

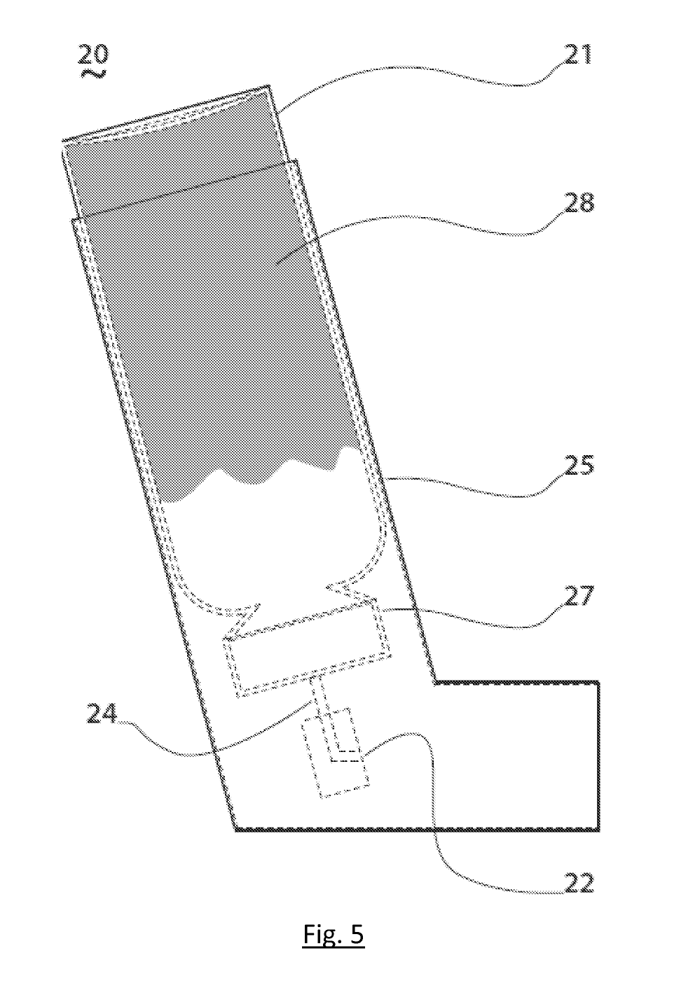

FIG. 5 is a is a cross sectional view of the teachings of the Vehicular Rear or Exterior Camera Lens Cleanser applicator shown in FIG. 3 with replaceable canister, the system 20 contains an aerosol spray canister 21 inserted into an applicator 25. The crimped metered valve 27 with metered valve stem 24 inserts into spray nozzle orifice 22 attached to the applicator 25. The crimped, metered valve 27 assures the pressurized cleansing solution 28 will not escape. The non-flammable, non-freezing cleansing solution 28 is comprised of a propellant and cleanser under pressure which will be expelled from canister 21 via spray orifice 22 when the metered valve stem 24 is activated by pressing the bottom of the canister 21. When the cleansing solution 28 is expelled from the canister 21 out of the spray orifice 22 from the metered valve stem 24, pressurized solution turns into an aerosol and once deposited on the camera lens, the cleansing solution 28 will erode and strip away the undesired debris on the lens.

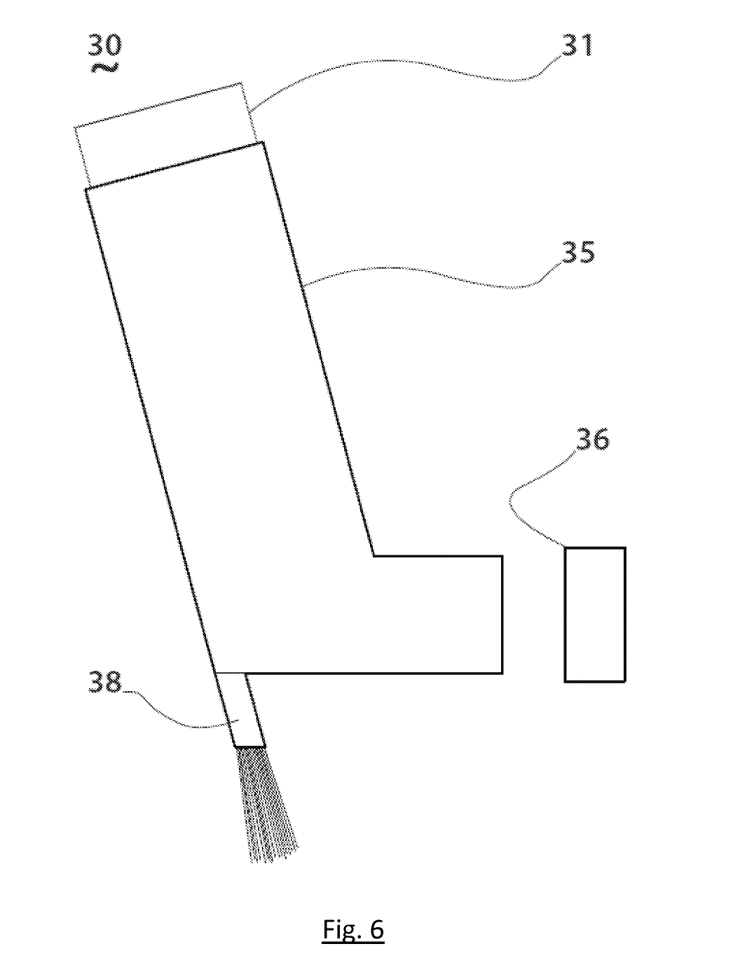

FIG. 6 is a perspective view of the teachings of the Vehicular Rear or Exterior Camera Lens Cleanser applicator system 30 with a non-abrasive integrated brush 38 and replaceable canister 31, the system 30 contains an aerosol spray canister 31 inserted into an applicator 35 with optional, non-abrasive integrated brush 38 attached to the open orifice end of the applicator. Undesired spray from the orifice is protected by removable cover 36. The optional non-abrasive integrated brush 38 can be used to remove remaining vehicular camera occlusion deposits.

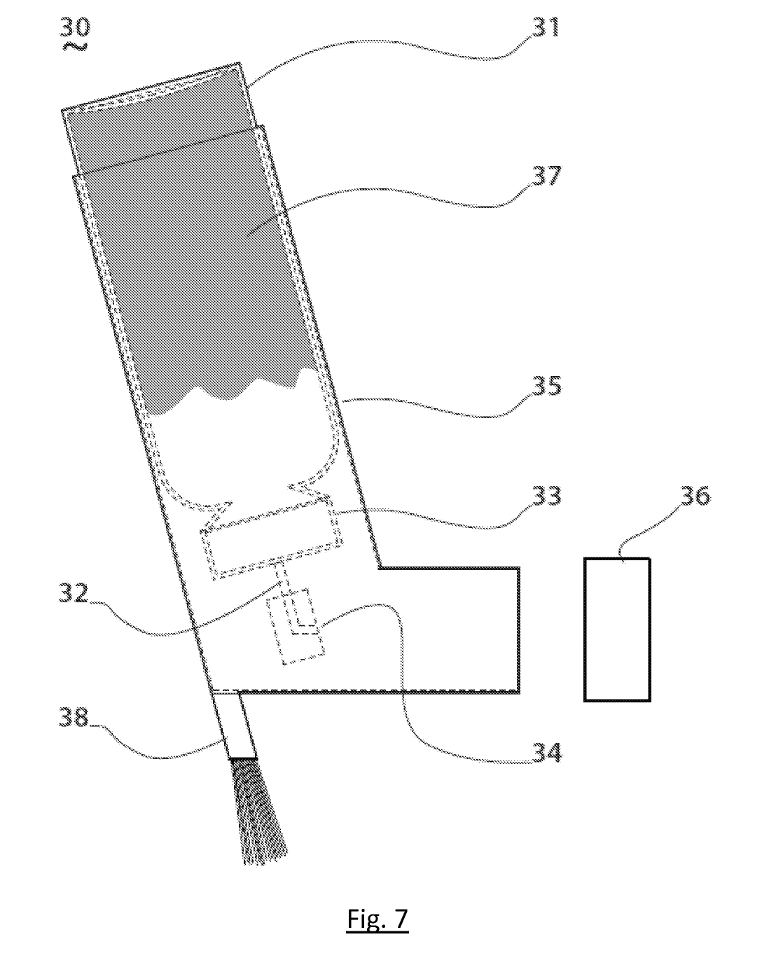

FIG. 7 is a cross-sectional view of the teachings of the Vehicular Rear or Exterior Camera Lens Cleanser applicator system with a non-abrasive integrated brush 38 shown in FIG. 6 with replaceable canister 31, the system 30 contains a canister 31 which is connected to a metered valve stem 32 via crimped, metered valve 33 connection. This assures the pressurized cleansing solution 37 will not escape the canister as long as the metered valve remains intact. The non-flammable, non-freezing pressurized cleansing solution 37, comprised of propellant and cleanser will be expelled from canister 31 when the metered valve stem 32 is activated to expel cleansing aerosol 37 through the spray nozzle orifice 34 by pressing the bottom of the canister 31. Optional non-abrasive integrated brush 38 attached to applicator 35 can be used to sweep away remaining debris from the vehicular camera lens. Undesired spray from the orifice is protected by removable cover 36.

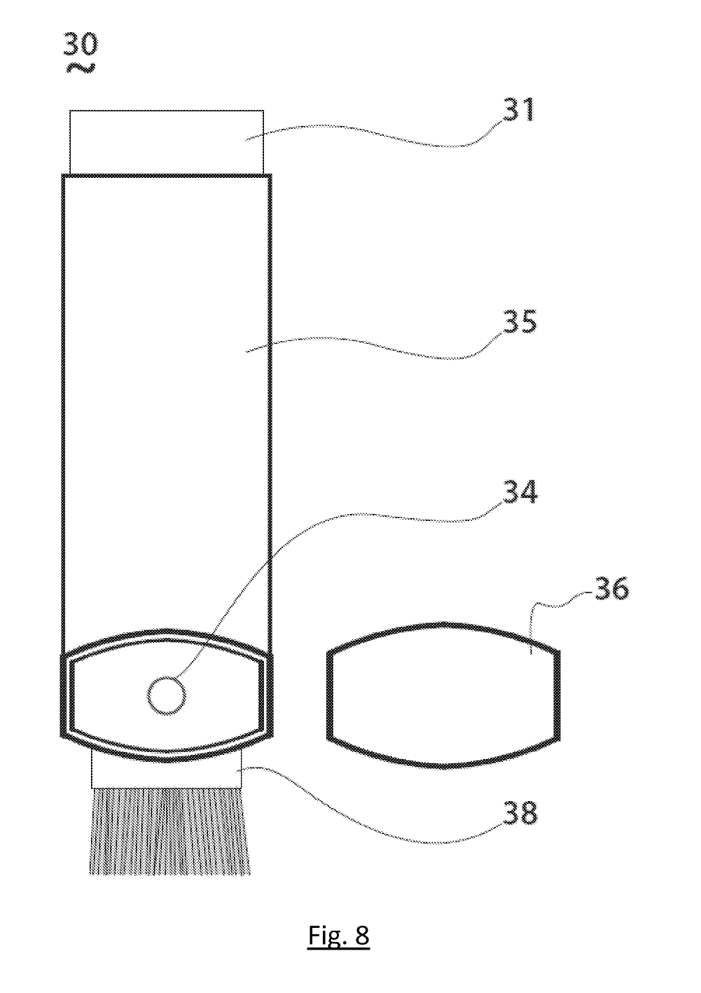

FIG. 8 is a front view of the teachings of the Vehicular Rear or Exterior Camera Lens Cleanser applicator system with non-abrasive integrated brush 38 shown in FIG. 6 with replaceable canister; system 30, the system contains a canister 31 filled with a pressurized cleansing solution which exits through spray orifice 34. An optional non-abrasive integrated brush 38 attached to applicator 35 can be used to sweep away remaining debris from the vehicular camera lens.

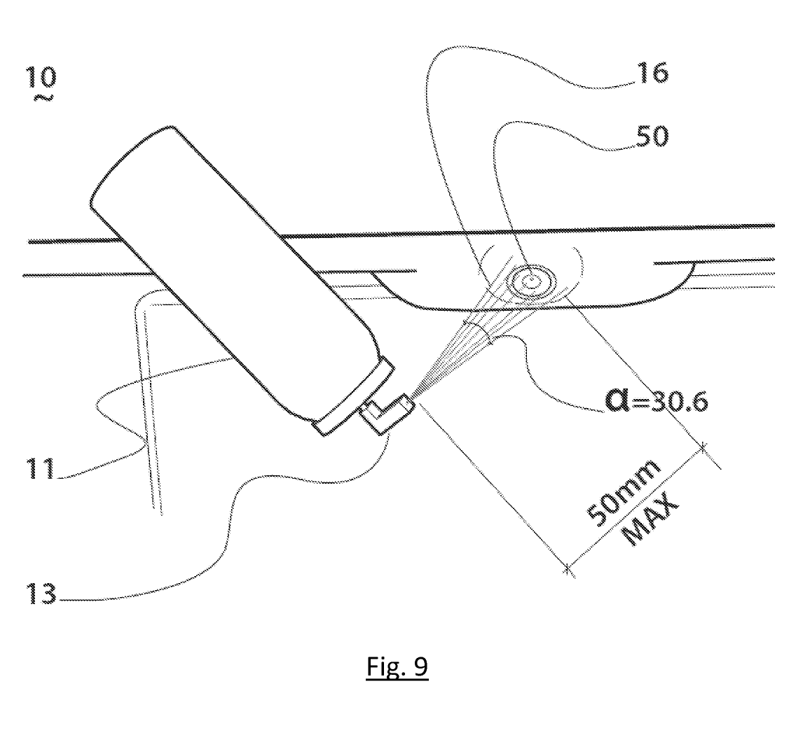

FIG. 9 is a perspective view of the teachings of the Vehicular Rear or Exterior Camera Lens Cleanser applied to the vehicle rear camera lens shown in FIG. 1, the canister 11, System 10 is shown in a position to direct the pressurized cleansing solution 16 upon the vehicular rear camera lens 50. The spray angle from the spray nozzle 13 orifice must range between 41.3 degrees to 19.8 degrees (nominal 30.6 degrees) to coincide with holding the spray apparatus 25 to 50 millimeters from the camera lens diameter which ranges from 18 to 22 millimeters.

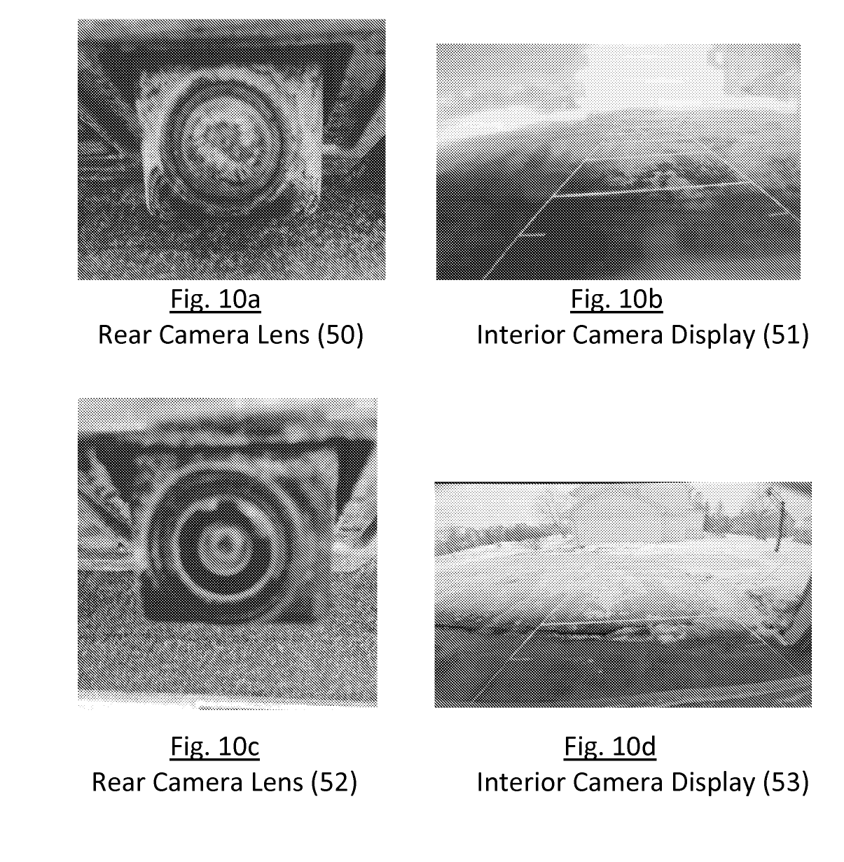

FIG. 10 image groupings, a, b, c & d are perspective views of the teachings of the Vehicular Rear or Exterior Camera Lens Cleanser vehicle rear camera lens and display screens before and after application of the cleansing solution. FIG. 10a represents a debris encrusted vehicular rear camera lens 50,

FIG. 10b represents a projected image on an interior rear camera view display 51 with its view occluded by debris,

FIG. 10c represents a debris cleansed vehicular rear camera lens 52,

FIG. 10d represents a projected image on an interior rear camera view display 53 with its view cleansed of debris by the application of spray from any of Systems 10, 20 or 30.

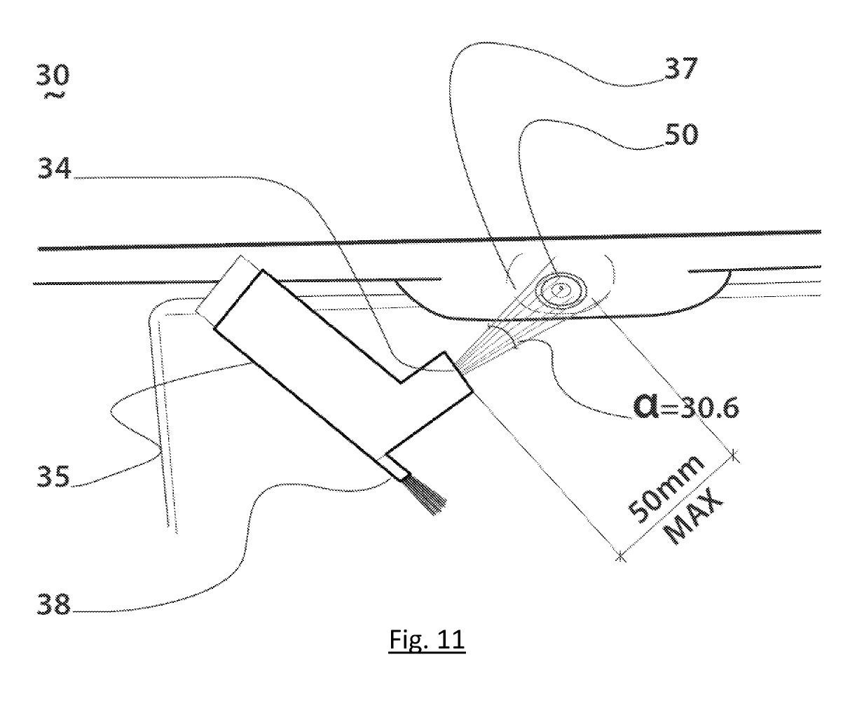

FIG. 11 is a perspective view of the teachings of the Vehicular Rear or Exterior Camera Lens Cleanser applicator 35 with a non-abrasive integrated brush 38 applied to the vehicle rear camera lens, the System 30 is shown in a position to direct the pressurized cleansing solution 37 upon the vehicular rear camera lens 50 to remove unwanted debris and if so desired, the non-abrasive integrated brush 38 attached to the applicator 35 can also be used to sweep away any remaining debris after the aerosol spray has been administered upon the vehicular rear camera lens 50. The spray angle from the applicator spray orifice 34 must range between 41.3 degrees to 19.8 degrees (nominal 30.6 degrees) to coincide with holding the applicator apparatus 25 to 50 millimeters from the camera lens diameter which ranges from 18 to 22 millimeters.

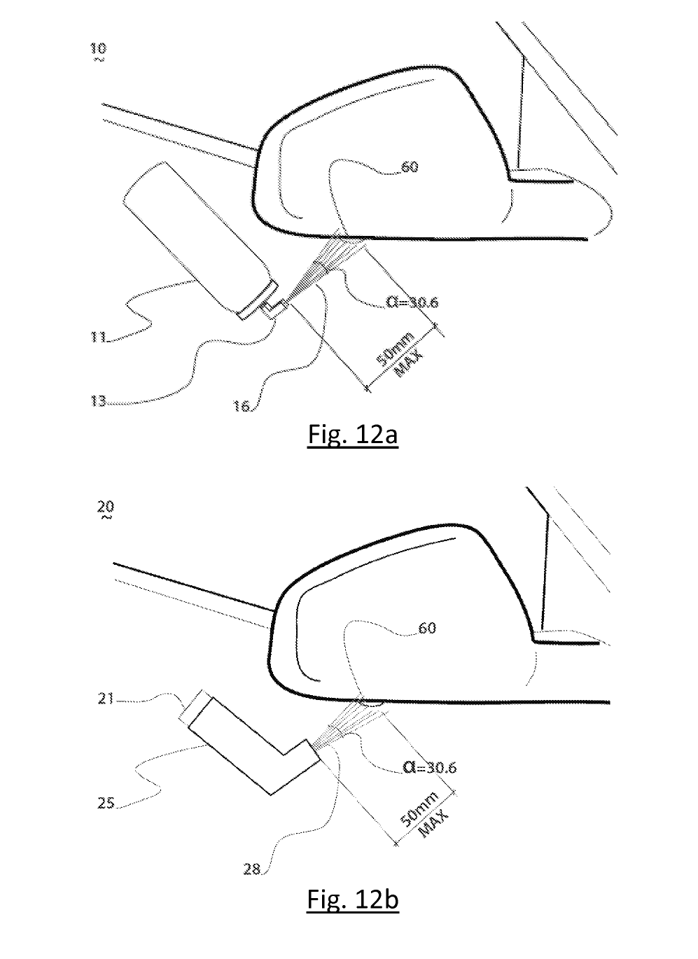

FIGS. 12(a) & (b) is a perspective view of the teachings of the Vehicular Rear or Exterior Camera Lens Cleanser, canister 11 or applicator 25 applied to the vehicle side mirror camera lens. In this description System 10 or alternately System 20 is shown in a position to direct the pressurized cleansing solution 16 or 28 upon the vehicular side mirror camera lens 60 to remove unwanted debris which may adversely affect its projected image and clarity on the interior camera view display which may affect the vehicle drivers ability to safely maneuver the vehicle in a lateral motion with confidence to avoid collisions. The spray angle from the canister spray nozzle 13 or applicator spray orifice must range between 41.3 degrees to 19.8 degrees (nominal 30.6 degrees) to coincide with holding the spray canister or applicator apparatus 25 to 50 millimeters from the camera lens diameter which ranges from 18 to 22 millimeters.

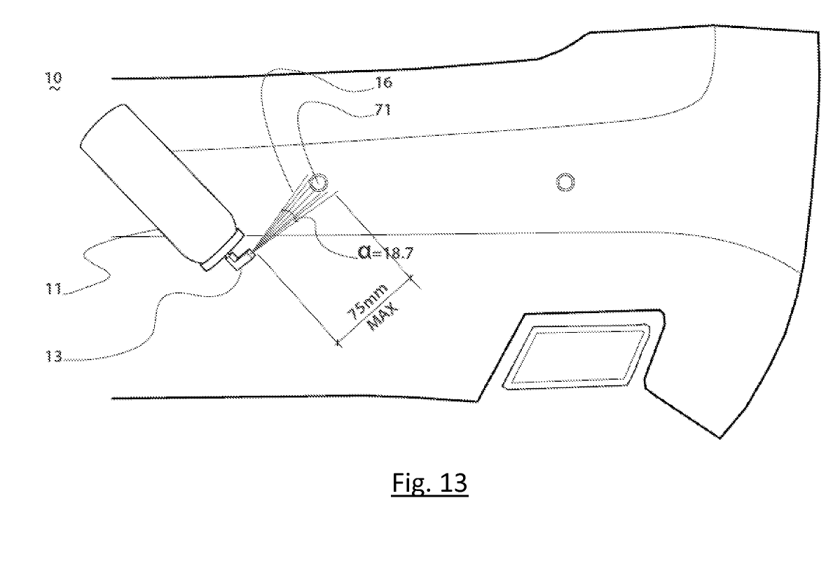

FIG. 13 is a perspective view of the teachings of the Vehicular Rear or Exterior Camera Lens Cleanser applied to the vehicle ultrasonic sensor fascia cover. The System 10 is shown in a position to direct the pressurized cleansing solution 16 upon any of the vehicular ultrasonic sensor fascia covers 71 to remove unwanted debris which may adversely affect the performance of the ultrasonic sensor which notifies a vehicle driver through an audible rear park assist system. The spray angle from the canister spray nozzle 13 at a minimum must range between 23.8 degrees to 13.5 degrees (nominal 18.7 degrees) to coincide with holding the spray canister 11 apparatus 50 to 75 millimeters from the ultrasonic sensor fascia cover diameter of approximately 20 millimeters.

What is claimed is:

1. A vehicular rear camera lens cleanser system comprising:
A lightweight and/or handheld spray dispensing apparatus (10) with a pressurized non-freezing cleansing solution in canister system wherein it can be utilized left or right handed.

2. The system according to claim 1 wherein the spray nozzle can rotate 360 degrees about the canister valve.

3. The system according to claim 1 wherein the handheld pressurized canister is capable of dispensing a non-freezing cleansing solution specifically to cleanse a vehicular rear or side mirror camera lens or ultrasonic sensor fascia cover with a combination of propellant and cleanser which is provided at a flow rate of 30 liters/minute for 200 milliseconds.

4. The system according to claim 1 wherein a spray nozzle has a defined spray pattern to cover up to a 22 millimeters diameter vehicular rear or side mirror camera lens or 20 millimeter ultrasonic sensor fascia cover.

5. The system according to claim 1 wherein there is a protective cap to prevent undesired cleansing solution discharge.

6. The system according to claim 1 where in the spray angle from the spray canister nozzle must range between 41.3 degrees to 19.8 degrees with a nominal 30.6 degrees to coincide with holding the spray canister nozzle 25 to 50 millimeters from the camera lens which ranges from 18 to 22 millimeters.

7. The system according to claim 1 where in the spray angle from the spray canister nozzle must range between 23.8 degrees to 13.5 degrees with a nominal 18.7 degrees to coincide with holding the spray canister nozzle 50 to 75 millimeters from the ultrasonic sensor fascia cover diameter of approximately 20 millimeters.

8. A vehicular rear camera lens cleanser system comprising:
An applicator that holds a pressurized canister (20) capable of dispensing a non-freezing cleansing solution.

9. The system according to claim 8 wherein there is an applicator with a defined spray orifice with a defined spray pattern to cover up to a 22 millimeters diameter vehicular rear or side mirror camera lens

10. The system according to claim 8 wherein the handheld pressurized canister within an applicator is capable of dispensing a non-freezing cleansing solution specifically to cleanse a vehicular rear or side mirror camera lens with a combination of propellant and cleanser which is provided at a flow rate of 30 liters/minute for 200 milliseconds.

11. The system according to claim 8 wherein the lightweight handheld spray dispensing apparatus with pressurized non-freezing cleansing solution in canister within applicator to aid in dispensing to the targeted spray area.

12. The system according to claim 8 wherein the optimal operating range of 25 to 50 millimeters.

13. The system according to claim 8 wherein the spray angle from the applicator spray orifice 35 must range between 41.3 degrees to 19.8 degrees, with a nominal 30.6 degrees to coincide with holding the applicator apparatus 25 to 50 millimeters from the camera lens which ranges from 18 to 22 millimeters.

14. A vehicular rear camera lens cleanser system comprising:
An applicator which holds a pressurized canister (30) capable of dispensing a non-freezing cleansing solution with an optional attached non-abrasive integrated brush which does not impede the canister-application discharge.

15. The system according to claim 14 wherein there is an applicator with a defined spray orifice with a defined spray pattern to cover up to a 22 millimeters diameter vehicular rear or side mirror camera lens

16. The system according to claim 14 wherein the handheld pressurized canister within an applicator is capable of dispensing a non-freezing cleansing solution specifically to cleanse a vehicular rear or side mirror camera lens with a combination of propellant and cleanser which is provided at a flow rate of 30 liters/minute for 200 milliseconds.

17. The system according to claim 14 wherein the lightweight handheld spray dispensing apparatus with pressurized non-freezing cleansing solution in canister within an applicator to aid in dispersing to the targeted spray area and wiping with an optional non-abrasive integrated brush.

18. The system according to claim 14 wherein the specified optimal operating range is 25 to 50 millimeters

19. The system according to claim 14 wherein the spray angle from the applicator spray orifice 35 must range between 41.3 degrees to 19.8 degrees, with a nominal 30.6 degrees to coincide with holding the applicator apparatus 25 to 50 millimeters from the camera lens which ranges from 18 to 22 millimeters.

20. The system according to claim 14 wherein the applicator has a non-abrasive integrated brush
